(19) United States
(12) Patent Application Publication
(10) Pub. No.: US 2001/0051878 A1
(43) Pub. Date: Dec. 13, 2001

(54) Global hub-to-hub exchange

(75) Inventor: Voon-Fee Yong, Singapore (SG)

Correspondence Address: GATES & COOPER LLP, HOWARD HUGHES CENTER, 6701 CENTER DRIVE WEST, SUITE 1050, LOS ANGELES, CA, 90045, US

(73) Assignee: bexcom pte. ltd.

(21) Appl. No.: 09/870,217

(22) Filed: May 29, 2001

Related U.S. Application Data
(60) Provisional application No. 60/208,812, filed on Jun. 2, 2000.

(51) Int. Cl. G06F 17/60

(52) U.S. Cl. 705/1

(57) ABSTRACT

One or more embodiments of the invention provide a method, apparatus, and article of manufacture for enabling global electronic transactions. Multiple hubs are maintained strategically and physically distributed in geographical regions around the world, wherein each hub can support a vertical e-marketplace. The hubs are interconnected to form a secure, persistent, recoverable, reliable, scalable global transaction infrastructure (GTI) network that enables each hub to communicate electronically with the other hubs. Business to business e-commerce services are provided on each hub through an internet trading center (ITC). Each ITC is configured to provide document exchange services for transactions within a geographic region and the ITC of two or mote hubs communicate together to provide document exchanges services for transactions between geographic regions. Additionally, each ITC is customized for the geographic region of each hub.

### CROSS-REFERENCE TO RELATED APPLICATIONS

This application claims the benefit under 35 U.S.C. Section 119(e) of the following co-pending and commonly-assigned U.S. provisional patent application(s), which is/are incorporated by reference herein:

Provisional Application Serial No. 60/208,812, filed Jun. 2, 2000, by Voon-Fee Yong, entitled “GLOBAL HUB-TO-HUB EXCHANGE,” attorneys' docket number 128.1-US-P1.

### BACKGROUND OF THE INVENTION

1. Field of the Invention

The present invention relates generally to electronic transactions, and in particular, to a method, apparatus, and article of manufacture for conducting global transactions electronically.

2. Description of the Related Art

The proliferation of computers and the Internet has resulted in fundamental changes in the way people communicate, work, obtain information, and conduct business. Software applications have been developed for large and small businesses for manufacturing, order entry, accounts receivable and payable, general ledger, purchasing, warehousing, transportation, human resources, etc. Such applications may be customized based on the needs for a particular business or department with a business/enterprise. Consequently, integrated information systems (commonly referred to as enterprise resource planning [ERP]) have been developed that serve all departments within an enterprise.

ERP implies the use of packaged software rather than proprietary software written by or for one customer. ERP modules may be able to interface with an organization's own software with varying degrees of effort, and, depending on the software, ERP modules may be alterable via the vendor's proprietary tools as well as proprietary or standard programming languages.

As a result of the exponential growth of the Internet, persons and businesses may desire to communicate or conduct business transactions (using their ERP system) such as orders, confirmations, and invoices electronically (e.g., across the Internet). Various protocols or formats may support the electronic communication of business transactions. Electronic data interchange (EDI) services enable organizations with different equipment to connect and communicate. EDI connections between two companies generally require specific integration into the systems of all counterparties and imply a direct computer to computer transactions into the databases and ordering systems of the parties. However, since EDI interfaces with a particular business' electronic infrastructure, any time a transaction with a new business is desired, EDI services must be customized to accommodate the new business' electronic infrastructure.

In addition to communicating between two businesses locally, the use of the Internet has enabled businesses to conduct transactions around the world. Accordingly, existing brick and mortar companies now desire to conduct global transactions.

Such global transactions give rise to a multitude of additional problems that may not be present in a purely local transaction. Such problems may include ensuring secure communication, validating users, coordinating payments from international banks, language barriers, ensuring receipt of communications (e.g., requests for quotes, quotes, purchase orders, sales orders, invoices, payments, etc.), the use of equivalent information, international shipping, etc. For example, since confidential information may be included in a global transaction, merely using a standard hypertext transfer protocol (HTTP) or secure socket layer (HTTPS) on the Internet to conduct a transaction is insufficient. Further, there is no mechanism available to ensure that a communication is received and has been processed in a foreign country. For example, there is no assurance that an order from an American business is received in its original and complete form and is being processed by a Japanese business.

### SUMMARY OF THE INVENTION

One or more embodiments of the invention provide a method, apparatus, and article of manufacture for conducting and/or enabling global electronic transactions. Two or more hubs are located and customized for a particular geographic area. The hubs are interconnected across a secure network such as a virtual private network. The network is referred to as a global transaction infrastructure (GTI). Information transmitted between hubs may be electronically secure through encryption techniques and may be authenticated and/or validated through a variety of certificate authorities.

On each hub, software (referred to as an internet trading center [ITC]) enables business-to-business e-commerce services. The ITC is customized for the geographic region of the hub where the ITC is installed and enables a document exchange service for securely exchanging documents required in a goods/services procurement cycle between businesses. The ITC interfaces within a business' existing backend system such that changes do not need to be made to an existing business' electronic transaction infrastructure. In addition to providing document exchange services for transactions within a hub's geographic region, each ITC is configured to communicate with the ITCs on other hubs to provide document exchange services for transactions between geographic regions.

### BRIEF DESCRIPTION OF THE DRAWINGS

Referring now to the drawings in which like reference numbers represent corresponding parts throughout:

FIG. 1 schematically illustrates a hardware and software environment in accordance with one or more embodiments of the invention;

FIG. 2 illustrates the hardware and software architecture in accordance with one or more embodiments of the invention;

FIG. 3 illustrates an example of the information flow through an internet trading center in accordance with one or more embodiments of the invention; and

FIG. 4 is a flow chart illustrating a method for enabling global electronic transactions in accordance with one or more embodiments of the invention.

### DETAILED DESCRIPTION OF THE PREFERRED EMBODIMENTS

In the following description, reference is made to the accompanying drawings which form a part hereof, and which is shown, by way of illustration, several embodiments of the present invention. It is understood that other embodiments may be utilized and structural changes may be made without departing from the scope of the present invention.

Overview

One or more embodiments of the invention provide a global transaction processing system including a document exchange service for the procurement of goods and/or services that may be customized for a geographical region. All of the transactions that are required in a procurement cycle (e.g., purchase order, payment, and delivery of the goods) are provided. Accordingly, a horizontal business to business (B2B) e-marketplace for global transactions is provided. Additionally, embodiments provide the ability to establish industry specific vertical e-marketplaces.

Hardware Environment

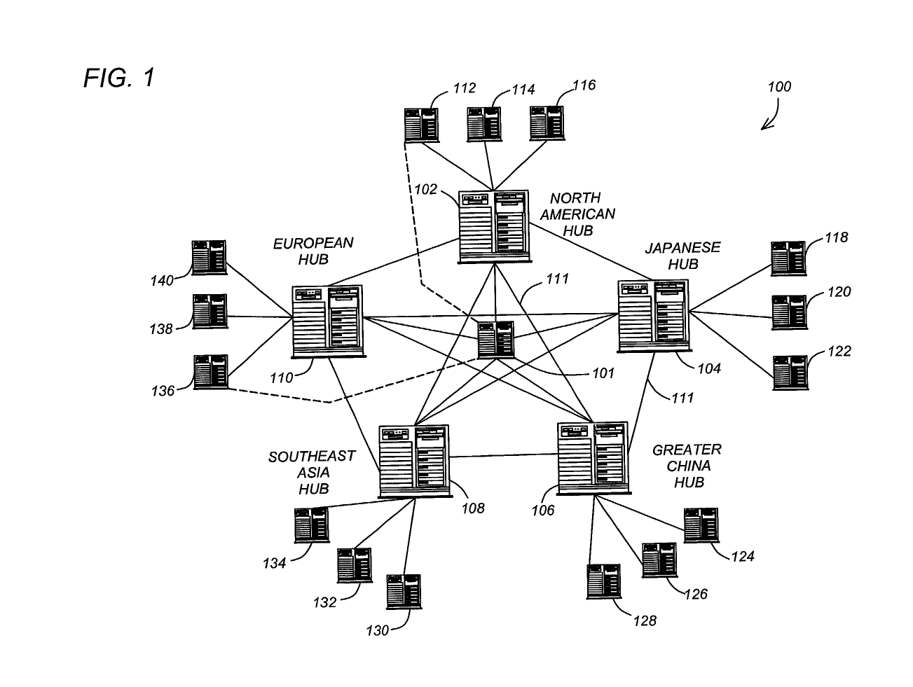

FIG. 1 schematically illustrates a hardware and software environment in accordance with one or more embodiments of the invention, and more particularly, illustrates a global transaction infrastructure 100 using a network (e.g., the Internet) to connect hubs 102-110 (referred to as regional hubs). Each regional hub 102-110 may be a personal computer, workstation, minicomputer, mainframe, or any other type of computer capable of communicating across a network.

The regional hubs 102-110 may be interconnected by a solid and reliable network infrastructure 111. For example, the network infrastructure 111 may include a high bandwidth connection that utilizes the Internet and a virtual private network (VPN) tunnel for security.

To provide a global transaction infrastructure, regional hubs 102-110 may be strategically located throughout the world. For example, regional hubs 102-110 may reside in major trading zones around the world such as North America 102, Japan 104, Greater China 106, Southeast Asia 108, and Europe 110. Accordingly, the ability to conduct transactions on a “global” level refers to more than multiple different parties participating inside of a transaction. A global transaction as used herein refers to conducting a transaction or a part of a transaction in two or more or between two or more parties located in different geographic regions.

Each regional hub 102-110 may communicate with the other regional hubs 102-110 and may support a vertical e-marketplace, franchise, or another hub 112-140 (which in turn may support another vertical e-marketplace, franchise, or hub). Each such vertical e-marketplace may be industry specific. For example, hubs 112-140 may represent a buyer, seller/merchant, bank, logistics company, or certificate authority. Each hub 112-140, or a third party service provider (also referred to as a provider of related services) may then provide support for additional services such as an ERP, a browser, email, a pager, a fax, etc.

In addition to the regional hubs 102-110, a central server/hub 101 or decision center may be utilized and located within a regional hub 102-110 or external to the regional hub 102-110. Such a central server/hub 101 may provide business intelligence, support for global failover, and/or other needed services for conducting global transactions between regional hubs 102-110. Further, additional hubs 112-140 may be directly connected to such a central hub 101 (as illustrated by dashed lines from hub 112 and hub 136) as a backup in case a regional hub 102-110 to which the hub (e.g., hubs 112 and 136) is connected is not available or is inoperable. Such a central hub 101 may also include an operation data store that contains replicated data for the other hubs 101-110 and 112-140 and serves as a global data backup.

Further, each hub 101-110 and 112-140 provides persistent and recoverable data. To provide such capabilities, redundant power generators, battery backup, and air conditioners may be used. Further, redundant power supplies and servers at each software layer may be utilized. Additionally, disk mirroring (such as that in a Raid 1+0 system) may be utilized. By storing documents persistently, each step in a transaction/negotiation cycle may be examined to resolve disputes.

Thus, embodiments of the invention may be implemented as a method, apparatus, or article of manufacture. The functions performed by these embodiments generally include logic and/or data embodied in or retrievable from a device, medium, carrier, or signal.

Those skilled in the art will recognize many modifications may be made to this exemplary environment without departing from the scope of the present invention. For example, those skilled in the art will recognize that any combination of the above components, or any number of different components, including different logic, data, different peripherals, and different devices, may be used to implement the present invention, so long as similar functions are performed thereby.

Software Embodiments

Business to business (B2B) e-commerce services provided by each hub 101-110 are powered by software referred to herein as an internet trading center (ITC). The ITC is an Internet based B2B transaction server engine that provides services to allow buyers and suppliers/merchants to complete the procurement of goods and/or services at every stage of a procurement lifecycle (e.g., from a request for quote to delivery of goods/services to financial settlements). The ITC provides for the elimination of manual business formalities (e.g., requesting quotes from multiple vendors, arranging financing, etc.) and transforms the business process into an integrated online business transaction process.

The ITC globally links buyers, sellers, banks, and logistics companies across a network 111. As described above, such buyers, sellers, banks, and logistics companies may operate within or are represented in FIG. 1 as hubs 112-140. The ITC provides such global links in a manner wherein business transactions are done securely through a seamless connection to certificate authorities for user authentication.

To provide flexibility, the ITC may be integrated into and utilized by a variety of business enterprises. For large buyers and suppliers, the ITC may be integrated into an existing back-end ERP and MRPII (manufacturing resource planning II—an information system that integrates all manufacturing and related applications, including decision support, material requirements planning [MRP], accounting and distribution) system. For smaller buyers and suppliers that do not require integration with a complex system, the ITC may provide a customized Web site or may link the small business with other enterprises across the Internet.

The ITC for each hub 102-140 is usually customized based on its geographic location or business needs. For example, the ITC may provide customized business documents and business processes for a geographic territory thereby minimizing disruption to business operations and workflow. By customizing the ITC for a particular hub 102-140, a vertical e-marketplace (the electronic services needed for a particular business) for an existing company/enterprise may be deployed without modifying or adjusting the manner within which the enterprise or business conducts business. Thus, a hub 102-140 may have a focus on localization. For example, the ITC may focus on logistics and banking for a particular region. To quickly integrate and customize the ITC with the existing infrastructure of large and small businesses, a variety of business processes, rules, and forms may be used in confirming the ITC for a particular business. Accordingly, as described, the ITC may be installed on both a hub 102-110 or on individual business systems 112-140.

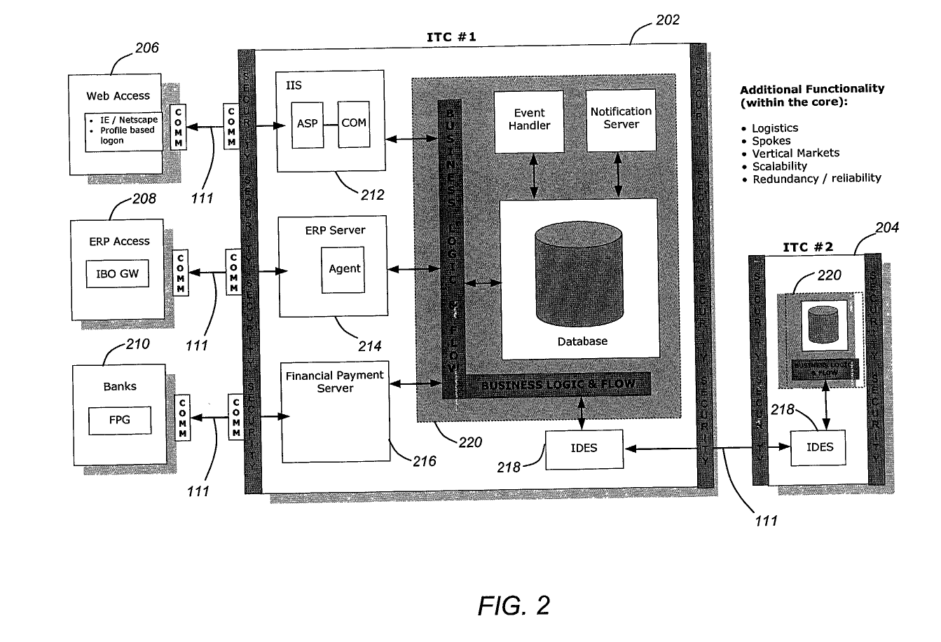

FIG. 2 further illustrates the hardware and software architecture in accordance with one or more embodiments of the invention. ITCs 202 and 204 are performed by hubs 102-110 and additional hubs 112-140 or services may provide or be utilized in conjunction with the services provided by ITCs 202 and 204. For example, software executing on a hub 112-140 may be used to provide web access services 206 by downloading the software from ITC 202 and installing it as a plug in or ActiveX control of a Web browser (e.g., Internet Explorer or Netscape). Web access services 206 may also utilize ActiveX components, component object model (COM), or distributed COM (DCOM) components to provide a user interface on a display. The Web server 212 that supports web access services 206 within ITC 202 may typically be a program such as Microsoft's Internet Information Server (IIS).

Web server 212 may host an Active Server Page (ASP) or Internet Server Application Programming Interface (ISAPI) application, which may be executing scripts. The scripts invoke objects that execute business logic (referred to as business objects). The business objects then manipulate data in a database through functions 220 of ITC 202.

To enable support for a variety of backend ERP software 208, ITC 202 may utilize an ERP server 214 that interfaces with a given ERP package 208 (or an internet business object gateway [IBO GW]) of a business. Such support may be enabled by mapping data from a particular business or hub 112-140 (e.g., the data as defined in the backend system of a business) to a canonical form that may be consistently and accurately used by the ITCs located geographically throughout the world. For example, the canonical form may comprise a standardized extensible markup language (XML) format that defines the fields and objects to be used in conducting a transaction. Additionally, a canonical form of the data may be used to conduct other aspects of a transaction such as shipping, financing, etc.

To provide support for financial transactions, a financial payment server 216 within ITC 202 may interface with a bank 210 and/or a financial payment gateway (FPG) of a bank. Security for financial transactions may be enabled through the network 111 infrastructure (referred to as a global transaction infrastructure [GTI]) and security provided with the ITC 202-204 and/or a financial payment gateway. Such security may provide, require, and/or utilize user verification, user authentication, content privacy, mandated preprocessing, and/or content integrity checking to provide for a secure financial transaction.

Each ITC (e.g., ITC 202 and 204) may be configured to verify the authenticity and identity of a party in a transaction through a variety of different available certificate authorities and/or digital signature technologies. With each hub potentially using a different certificate authority, the GTI allows transactions between multiple independent certificates who establish a cross-hub trust through a secure chain of responsibility. Accordingly, if a buyer, seller, and/or bank uses different certificate authorities, the ITC will act as a central verification system with the ability to verify the authenticity, identity, and/or validity of any party in a transaction.

Further, the ITC may enable transactions between parties in a transaction that utilize different encryption/verification systems. For example, the ITC may verify the identify of a first party in a transaction using digital signature technology and not verify the identify of another party in the transaction. Alternatively, the ITC may verify the identity of two or more parties in the transaction using digital signature technology. In yet another alternative, the ITC may not verify the identity of any of the parties in a transaction using digital signature technology. Thus, the ITC enables users preferring different levels of security (e.g., a user name and password, a secure socket layer, digital signature technology, etc.) to complete a transaction.

As illustrated in FIG. 2, services 206-210 may be provided by a regional hub 102-110 or by other hubs 112-140 that provide services for the regional hubs 102-110. An ITC in a regional hub is customized for a particular geographic region to provide the services for that particular regional hub or geographic region 206-210. Thereafter, the ITC 202 may communicate and enable global transactions by interacting through Internet Document Exchange Service (IDES) 218 with an ITC located within another regional hub 102-110.

Communications between ITCs 202 and 204 and with services 206-210 are conducted across network 111. ITCs provide a security layer to provide the appropriate services to a user. Additionally, the communication from an ITC across a network 111 may be through a secure connection such as a global virtual private network (VPN) or a hardware firewall device. Thus, the communication across the GTI network 111 utilizes encryption. As a result, the network infrastructure 111 and ITCs provide a secure, persistent, recoverable, reliable, and scalable GTI that enables each hub 102-110 and 112-140 to globally electronically communicate with other hubs 102-110 and 112-140.

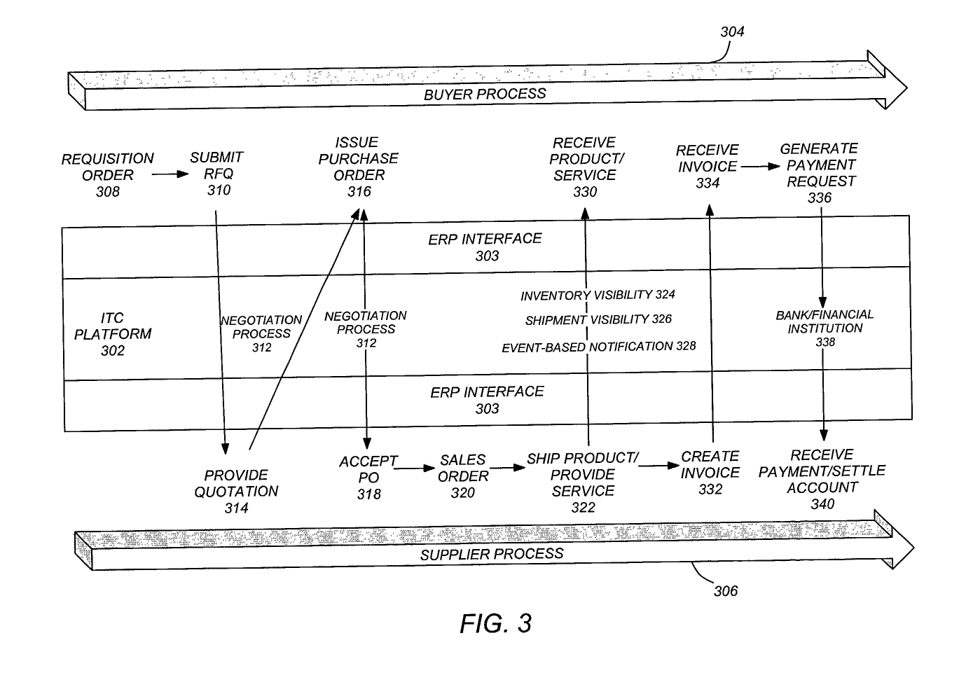

An example of the information flow through an ITC is illustrated in FIG. 3. The ITC platform 302 manages transactions in a goods and services procurement cycle through ERP interfaces 303 of a buyer and supplier. FIG. 3 illustrates the exchange of information and data as the procurement process proceeds through a buyer's business cycle 304 and supplier's business cycle 306. As illustrated, the ITC platform 302 interfaces with any ERP system 303 and does not intrude on the back end system of the buyer or seller.

At step 308, a buyer requisitions an order (i.e., determines what product or service is needed). At step 310, the buyer submits a request for a quote (RFQ) from one or more suppliers. Such a request often provides detailed information regarding the particular type of product/service and the amount of the product/service needed.

Through a negotiation process 312 between the buyer and the seller, the supplier provides a quotation at step 314 for the product or service, and the seller issues a purchase order for the product/service at step 316. Further negotiations may then occur (e.g., if a significant time has passed between the RFQ data and the quotation provided) with the end result of a supplier accepting the purchase order at step 318. The supplier issues a sales order at step 320, ships the product/service to the supplier at step 322, and creates an invoice at step 332.

Through the ITC platform 302, the inventory 324 and shipping 326 may be visible through event based notification 328 in the shipping process (i.e., using a tracking number or scan locations throughout the world). For example, event based notification may provide notifications to parties of a transaction as various stages/aspects of the transaction proceed. At step 330, the buyer receives the product/service and receives the invoice at step 334. In response, the buyer generates a payment request at step 336. A bank/financial institution 338 receives the payment request and completes the financial transaction wherein the supplier receives the payment to settle the account at step 340. Such financial transactions are likely conducted over the secure network 111 provided using the network infrastructure and ITC platform 302. Further, the validation, certification, etc. of the entities participating in the financial transaction are completed by the ITC platform 302 to ensure the completion of the transaction.

As illustrated in FIG. 3, vital steps in the procurement cycle are processed within the ITC platform 302. Further, as described above, the ITC 302 at each regional hub 102-110 is customized for the particular geographic area. For example, ITC 302 may be customized to provide electronic banking in compliance with a particular geographic area's standards (e.g., at the European hub 110). In the prior art, all of the above steps could not be processed by a single application or could not be processed at all on such a global level. The ITC enables a secure mechanism for delivering and processing transaction messages to ensure that numerous transactions in the procurement cycle are complete and accurate.

Further, ITC 302 supports any protocol, security standard, or certificate authority used throughout the transaction process. Such support is highly desirable when a financial transaction is being conducted between entities distributed throughout the world.

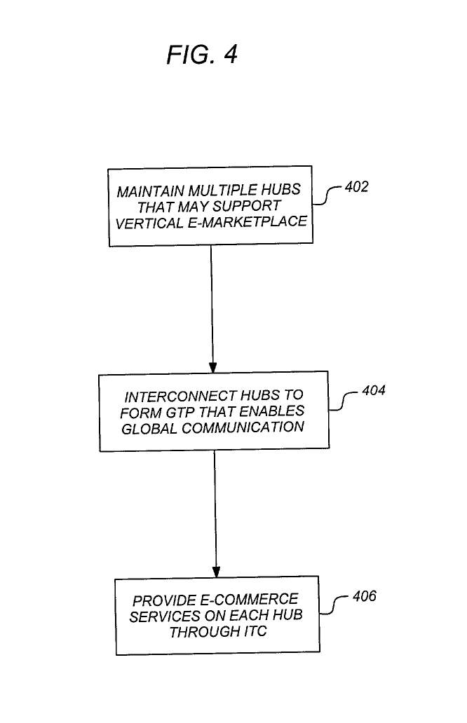

FIG. 4 is a flow chart illustrating a method for enabling global electronic transactions in accordance with one or more embodiments of the invention. At step 402, multiple hubs (i.e., regional hubs 102-110) are maintained in strategically and physically distributed geographical regions around the world. Additionally, each hub may support a vertical e-marketplace or another hub (e.g., hubs 112-140). At step 404, the multiple hubs 102-110 are interconnected across network 111 to form a secure persistent, recoverable, reliable, scalable global transaction infrastructure (GTI) network. Using the GTI network, each hub 102-110 is enabled to communicate electronically with the other hubs.

At step 406, business to business e-commerce services on each hub 102-110 are provided through an ITC 202-204. The ITC 202-204 on each hub 102-110 provides a document exchange service that permits the secure exchange of electronic documents required for all transactions occurring in a goods/services procurement cycle. Further, the ITC 202-204 is customized for the geographic region for the hub 102-110 where the ITC is operating. Accordingly, the ITC 202-204 provides for document exchange services for transactions within the geographic region it represents. Further, two or more ITCs 202-204 may work in collaboration together to provide document exchange services for transactions between geographic regions. Thus, the ITCs 202-204 on the GTI network enable electronic transactions on a global level.

Conclusion

This concludes the description of one or more embodiments of the invention. The following describes some alternative embodiments for accomplishing the present invention. For example, any type of computer, such as a mainframe, minicomputer, or personal computer, or computer configuration, such as a timesharing mainframe, local area network, or standalone personal computer, could be used with the present invention.

In summary, embodiments of the invention provide a method, apparatus, and article of manufacture for conducting electronic commerce/transactions globally in a secure, persistent, recoverable, reliable, and scalable manner.

The foregoing description of the preferred embodiment of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto.

What is claimed is:

1. A method for enabling global electronic transactions comprising:
(a) maintaining multiple computer-implemented hubs strategically and physically distributed in geographical regions, wherein each hub is configured to support a vertical e-marketplace;
(b) interconnecting the multiple hubs to form a secure, persistent, recoverable, reliable, scalable global transaction infrastructure (GTI) network that enables each hub to communicate electronically with other hubs;
(c) providing business to business e-commerce services on each hub through an internet trading center (ITC), wherein the ITC on each hub:
(1) is customized for the geographic region of each hub; and
(2) provides a document exchange service for securely exchanging electronic documents required for all business transactions, wherein the document exchange service supports transactions within a geographic region and the ITC communicates with the ITC of another hub to provide the document exchange service for transactions between geographic regions.

2. The method of claim 1 wherein the business transactions occur in a goods and services procurement cycle that comprises:
a purchase order;
a payment; and
a delivery of the goods and services.

3. The method of claim 1 wherein each hub may provide the ability to establish industry specific vertical e-marketplaces.

4. The method of claim 1 wherein the vertical e-marketplace comprises a mapping of data from a party involved in a transaction to a canonical form without modifying the manner within which the party conducts business.

5. The method of claim 4 wherein the canonical form comprises an extensible markup language (XML) format.

6. The method of claim 4 wherein a party involved in the transaction is a merchant.

7. The method of claim 4 wherein a party involved in the transaction is a buyer.

8. The method of claim 4 wherein a party involved in the transaction is a bank.

9. The method of claim 4 wherein a patty involved in the transaction is a provider of related services.

10. The method of claim 1 wherein the five hubs are interconnected using the Internet and a virtual private network (VPN) tunnel.

11. The method of claim 1 wherein a first identity of a first party in a transaction is verified using digital signature technology and a second identity of a second party in the transaction is not verified using digital signature technology.

12. The method of claim 1 wherein identities of two parties in a transaction are verified using digital signature technology.

13. The method of claim 1 wherein the security of the global transaction infrastructure (GTI) network utilizes encryption.

14. The method of claim 1 wherein the security of the global transaction infrastructure (GTI) utilizes technology available through a certificate authority.

15. The method of claim 1 wherein the geographic regions ate strategically and physically distributed around the world.

16. The method of claim 15 wherein hubs are located in North America, Southeast Asia, Greater China, Japan, and Europe.

17. The method of claim 1 wherein each vertical e-marketplace is configured to support another vertical e-marketplace.

18. A computer implemented processing system for global transactions comprising:
(a) multiple computer implemented hubs strategically and physically distributed in geographical regions, wherein each hub is configured to:
(1) support a vertical e-marketplace; and
(2) interconnect with other hubs to form a secure, persistent, recoverable, reliable, scalable, global transaction infrastructure (GTI) network that enables each hub to communicate directly with other hubs;
(b) an internet trading center (ITC) application executing on each hub to provide a document exchange service for securely exchanging electronic documents requited for all business transactions, wherein the ITC application is customized for the geographic region of each hub and is configured to:
(1) provide the document exchange service for transactions within a geographic region; and
(2) communicate with an ITC of another hub to provide the document exchanges service for transactions between geographic regions.

19. The system of claim 18 wherein the business transactions occur in a goods and services procurement cycle that comprises:
a purchase order;
a payment; and
a delivery of the goods and services.

20. The system of claim 18 wherein each hub is further configured to provide the ability to establish industry specific vertical e-marketplaces.

21. The system of claim 18 wherein the vertical e-marketplace comprises a mapping of data from a party involved in a transaction to a canonical form without modifying the manner within which the party conducts business.

22. The system of claim 21 wherein the canonical form comprises an extensible markup language (XML) format.

23. The system of claim 21 wherein a party involved in the transaction is a merchant.

24. The system of claim 21 wherein a party involved in the transaction is a buyer.

25. The system of claim 21 wherein a party involved in the transaction is a bank.

26. The system of claim 21 wherein a party involved in the transaction is a provider of related services.

27. The system of claim 18 wherein the five hubs are interconnected using the Internet and a virtual private network (VPN) tunnel.

28. The system of claim 18 wherein a first identity of a first party in a transaction is verified using digital signature technology and a second identity of a second party in the transaction is not verified using digital signature technology.

29. The system of claim 18 wherein identities of two parties in a transaction are verified using digital signature technology.

30. The system of claim 18 wherein the security of the global transaction infrastructure (GTI) network utilizes encryption.

31. The system of claim 18 wherein the security of the global transaction infrastructure (GTI) utilizes technology available through a certificate authority.

32. The system of claim 18 wherein the geographic regions are strategically and physically distributed around the world.

33. The system of claim 32 wherein hubs are located in North America, Southeast Asia, Greater China, Japan, and Europe.

34. The system of claim 18 wherein each vertical e-marketplace is configured to support another vertical e-marketplace.

35. An article of manufacture comprising a program storage medium readable by a computer and embodying one or more instructions executable by the computer to perform a method for enabling global electronic transactions in a computer system, the method comprising:
(a) maintaining multiple computer-implemented hubs strategically and physically distributed in geographical regions, wherein each is configured to support a vertical e-marketplace;
(b) interconnecting the multiple hubs to form a secure, persistent, recoverable, reliable, scalable global transaction infrastructure (GTI) network that enables each hub to communicate electronically with the other hubs;
(c) providing business to business e-commerce services on each hub through an internet trading center (ITC), wherein the ITC on each hub:
(1) is customized for the geographic region of each hub; and
(2) provides a document exchange service for securely exchanging electronic documents required for all business transactions, wherein the document exchange service supports transactions within a geographic region and the ITC communicates with the ITC of another hub to provide the document exchange service for transactions between geographic regions.

36. The article of manufacture of claim 35 wherein the business transactions occur in a goods and services procurement cycle that comprises:
a purchase order;
a payment; and
a delivery of the goods and services.

37. The article of manufacture of claim 35 wherein each hub may provide the ability to establish industry specific vertical e-marketplaces.

38. The article of manufacture of claim 35 wherein the vertical e-marketplace comprises a mapping of data from a party involved in a transaction to a canonical form without modifying the manner within which the party conducts business.

39. The article of manufacture of claim 38 wherein the canonical form comprises an extensible markup language (XML) format.

40. The article of manufacture of claim 38 wherein a party involved in the transaction is a merchant.

41. The article of manufacture of claim 38 wherein a party involved in the transaction is a buyer.

42. The article of manufacture of claim 38 wherein a party involved in the transaction is a bank.

43. The article of manufacture of claim 38 wherein a party involved in the transaction is a provider of related services.

44. The article of manufacture of claim 35 wherein the five hubs are interconnected using the Internet and a virtual private network (VPN) tunnel.

45. The article of manufacture of claim 35 wherein a first identity of a first party in a transaction is verified using digital signature technology and a second identity of a second party in the transaction is not verified using digital signature technology.

46. The article of manufacture of claim 35 wherein identities of two parties in a transaction are verified using digital signature technology.

47. The article of manufacture of claim 35 wherein the security of the global transaction infrastructure (GTI) network utilizes encryption.

48. The article of manufacture of claim 35 wherein the security of the global transaction infrastructure (GTI) utilizes technology available through a certificate authority.

49. The article of manufacture of claim 35 wherein the geographic regions are strategically and physically distributed around the world.

50. The article of manufacture of claim 43 wherein hubs are located in North America, Southeast Asia, Greater China, Japan, and Europe.

51. The article of manufacture of claim 35 wherein each vertical e-marketplace is configured to support another vertical e-marketplace.
